(19) United States
(12) Patent Application Publication
(10) Pub. No.: US 2014/0305235 A1
(43) Pub. Date: Oct. 16, 2014

(54) VIBRATION EXCITER FOR CONSTRUCTION MACHINES

(71) Applicant: ABI Anlagentechnik-Baumaschinen-Industriebedarf Maschinenfabrik und Vertriebsgesellschaft mbH, Niedernberg (DE)

(72) Inventors: Albrecht KLEIBL, Grosshennersdorf (DE); Christian HEICHEL, Niedernberg (DE)

(73) Assignee: ABI Anlagentechnik-Baumaschinen-Industriebedarf Maschinenfabrik und Vertriebsgesellschaft mbH, Niedernberg (DE)

(21) Appl. No.: 14/205,488

(22) Filed: Mar. 12, 2014

(30) Foreign Application Priority Data
Apr. 10, 2013 (EP) 13163221.8

(51) Int. Cl. B06B 1/18; E02D 7/18; B06B 1/16

(52) U.S. Cl. CPC B06B 1/186; B06B 1/162; E02D 7/18
USPC 74/61; 73/49; 91/232

(57) ABSTRACT

A pivot motor, particularly for a vibration exciter for construction machines, has a pivot motor housing that is mounted so as to rotate on a pivot motor shaft. At least two pressure chambers to which a hydraulic oil is to be supplied are provided, by way of which oil the pivot motor can be driven. The pivot motor shaft is provided with an axial bore, into which a lance disposed in torque-proof manner projects, through which lance axially at least two channels for supplying oil to the pivot motor are passed, which end in ring grooves introduced on the outside of the lance, at least in certain regions, at a distance from one another. Radial bores for connecting the at least two ring grooves of the lance with the at least two pressure chambers are introduced into the pivot motor shaft.

### CROSS REFERENCE TO RELATED APPLICATIONS

Applicant claims priority under 35 U.S.C. §119 of European Application No. 13163221.8 filed Apr. 10, 2013, the disclosure of which is incorporated by reference.

### BACKGROUND OF THE INVENTION

1. Field of the Invention

The invention relates to a pivot motor, particularly for a vibration exciter for construction machines, particularly for vibration pile drivers.

2. Description of the Related Art

In construction, vibration pile drivers are used to introduce materials to be pile-driven, such as profiles, for example, into the ground, or to draw them from the ground. The ground is excited using vibrations having a frequency above the natural frequency of the ground, and thereby achieves a “pseudo-fluid”state. The goods to be driven in can then be pressed into the construction ground using a static top load. The vibration is generated by rotating imbalances that run in opposite directions, in pairs.

The vibration exciters of such vibration pile drivers are vibration exciters that act in linear manner, the centrifugal force of which is generated by means of rotating imbalances. An essential characteristic of these vibration exciters is the static moment. This variable describes the installed imbalance. In vibration exciters configured as adjustable vibrators, the active variable of the imbalance is adjustable. In order to limit the roller bearing stress, adjustment of the static moment takes place by means of adjustment of the active imbalance of each shaft. In general, a center imbalance is rotated relative to two outer imbalances, in order to set the resulting imbalance in this manner. Because the inner imbalances of all the shafts are connected with one another by way of gear wheels, and the outer imbalances of all the shafts are connected with one another by way of gear wheels or by way of the shafts themselves, the relative angles between outer and inner imbalances are the same on all the shafts. A vibration exciter configured in this manner is disclosed, for example, in DE 20 2007 005 283 U1. In this connection, adjustment of the imbalance groups takes place by way of a pivot motor that is structured as a rotating gear shaft. The adjustment takes place by way of a rotating piston to which pressure oil is applied. This piston can rotate within the pivot motor housing, relative to the pivot motor housing.

Fundamentally, transfer of the oil to the rotating pivot motor is required for operation of such pivot motors. Usually, rotary feed-throughs are used for this purpose, in the state of the art, which consist of a fixed housing that is flanged onto the housing of the vibration exciter, and of a rotor that is mounted in this housing, so as to rotate, and is also driven by the rotating pivot motor. Bearings always have a bearing play, thereby causing all the components mounted in a vibrating housing to rotate with a certain eccentricity. Although this eccentricity is relatively great in the case of self-mounted pivot motors, very tight plays are required in rotary feed-throughs, for reasons of sealing technology. A direct, rigid connection between the rotor of the rotary feed-through and the pivot motor shaft is not possible, because the heavy pivot motor would damage the sensitive bearings of the rotary feed-through. Currently, attempts are being made to solve this problem by means of the use of small, flexible tubes placed in between, which are attached, on the one hand, in sealed manner, in face-side bores of the pivot motor shaft, and, on the other hand, also in sealed manner, on the rotor of the rotary pass-through. In this way, a connection that is movable on both sides is achieved.

The aforementioned solution has the disadvantages of being very complicated to produce and furthermore of requiring a large amount of construction space, because the rotary pass-through is built toward the outside and is situated in an exposed position in front of the housing. Furthermore, sealing of the small tubes takes place using O-rings, which are subject to great wear on the basis of dynamic stress, and for this reason have to be replaced frequently.

### SUMMARY OF THE INVENTION

The invention wants to provide a remedy of these disadvantages. The invention is based on the task of making available a pivot motor, particularly for a vibration exciter for construction machines, the production and maintenance effort of which is reduced, particularly with regard to its oil supply, and which furthermore takes up little construction space. According to the invention, this task is accomplished by a pivot motor, particularly for a vibration exciter for construction machines, having a pivot motor housing that is mounted so as to rotate on a pivot motor shaft. At least two pressure chambers to which a hydraulic oil is to be supplied are provided, by way of which oil the pivot motor can be driven. The pivot motor shaft is provided with an axial bore, into which a lance disposed in torque-proof manner projects, through which lance axially at least two channels for supplying oil to the pivot motor are passed, which end in ring grooves introduced on the outside of the lance, at least in certain regions, at a distance from one another. Radial bores for connecting the at least two ring grooves of the lance with the at least two pressure chambers are introduced into the pivot motor shaft. The fit between the lance and the axial bore of the pivot motor shaft is structured as a tight slide bearing in the region of the ring grooves of the lance.

With the invention, a pivot motor is created, particularly for a vibration exciter for construction machines, the production and maintenance effort of which is reduced, particularly with regard to its oil supply, and which furthermore takes up little construction space. An axial bore is provided in the pivot motor shaft, into which a lance disposed in torque-proof manner projects, through which lance axially at least two channels are passed, which end in grooves introduced on the outside of the lance, at least in certain regions, adjacent to one another on the outside of the lance. Radial bores for connecting the at least two ring grooves of the lance with the at least two pressure chambers are introduced into the pivot motor shaft. As a result of this arrangement, a reliable and, at the same time, “elastic” oil supply to the pivot motor is achieved. The lance disposed in fixed manner balances out the dancing movement of the pivot bearing shaft in the roller bearings, which demonstrate play as part of their function. This balance is achieved, on the one hand, by means of the long shaft of the lance, which is preferably structured to be elastic, and is advantageously structured by means of an attachment on the housing of the vibration exciter, in such a manner that it can absorb slightly slanted positions. In this connection, the lance is preferably mounted so as to prevent rotation, at the end side, with play, in a flange part attached to the housing of the vibration exciter. The elasticity of the lance can be increased in that it is configured with a reduced diameter in the region of the shaft.

The oil supply of the chambers comes from the outside. The oil is first passed through the at least two axial channels of the lance, all the way to the region of the shaft, which is enclosed by the pivot motor housing. The two channels have different lengths and open into a groove, in each instance, which encloses the lance at the height of the ends of the bores. On the shaft side, a radial bore opens into this groove, by way of which bore a chamber of the pivot motor is supplied with oil.

In a further development of the invention, the lance and the axial bore of the pivot motor shaft are configured as slide bearings with very tight play in the region of the ring grooves of the lance or preferably in the region of the pivot motor shaft, which is enclosed by the pivot motor housing. The tight gap between the mantle surface of the lance and the axial bore of the pivot motor shaft serves to seal the at least two grooves relative to one another, as well as relative to the vibration exciter interior. In this connection, the surface of the lance is preferably provided with a slide coating, preferably a plastic coating, which is preferably applied as a varnish, in the region of this slide bearing.

In an embodiment of the invention, no slipping seals are present over the length of the fit between the lance and the axial bore of the pivot motor shaft, in the region of the ring grooves of the lance. As a result, a small amount of leakage exits through the slide bearing having a small gap. This leakage serves to lubricate the slide bearing and separates the surfaces, thereby counteracting friction wear.

In a further development of the invention, the lance has a head piece on the end side, which is increased in diameter, with which piece it is mounted in the flange part. In this way, resilient attachment of the lance in the flange is made possible. For this purpose, the gap between lance and flange part, formed by the play, is preferably bridged by at least one O-ring. The lance can be secured to prevent rotation, by means of an alignment pin that engages into the head piece.

In a further embodiment of the invention, the pivot motor is configured as a single-vane or two-vane rotary piston pivot motor. Rotary piston pivot motors, also called rotary vane pivot motors, generate a torque directly, by means of one or more vanes disposed on the pivot motor shaft, to which vanes hydraulic oil is applied under pressure. When one vane is disposed on the pivot motor shaft, the rotary piston pivot motor is referred to as a single-vane motor. When two vanes are disposed on the pivot motor shaft, the rotary piston pivot motor is referred to as a two-vane motor.

In the case of a single-vane configuration of the pivot motor, the pivot motor housing of the pivot motor is preferably configured as an imbalance in the shape of a circle segment. In this way, a space-optimized imbalance is formed by the pivot motor housing itself. A significant reduction in the required construction space is made possible by the use of a pivot motor configured in such a manner, in a vibration generator for construction machines; in particular, no separate shaft is required for a phase shifter.

In a further development of the invention, the angle of rotation of the rotary vane of the pivot motor configured in single-vane manner is limited by a stop surface, in each instance, of two stops disposed on the pivot motor housing. At least one oil pocket to which oil can be applied is formed between the two stops, opposite the pivot space of the rotary vane defined by the pivot angle. In order to supply oil to the at least one oil pocket, at least one separate channel is provided, in addition to the supply channels of the pressure chambers disposed on both sides of the rotary vane. This channel is connected with a supply bore of the hollow shaft, opening into the at least one oil pocket, by way of a ring groove disposed on the outside of the lance. In this way, at least partial compensation of the resulting force acting on the bearings is achieved. Because the pivot motor housing is configured as an imbalance, the bearings with which the pivot motor housing is mounted on the pivot motor shaft are increasingly stressed by the centrifugal force, with an increasing speed of rotation. In addition, there is a bearing force that results from the oil pressure in the chambers of the pivot motor. This bearing load, resulting from centrifugal force and oil pressure in the chambers, leads to an increased adjustment moment, which is reduced by providing the at least one oil pocket. A hydraulic short-circuit between the two chambers of the pivot motor is excluded by the placement of a separate channel for supplying oil to the oil pocket. Alternatively, two kick-back valves or also a shuttle valve can be provided. Valves are sensitive, however, to dynamic stresses, which are unavoidable in a vibrator transmission.

In a further development of the invention, the maximal pivot angle of the rotary vane amounts to less than 180°, preferably less than 160°, preferentially 150° or less. In this way, the greatest possible imbalance at a low mass of the pivot motor housing is made possible. From the reduction of the pivot angle known from the state of the art, 180°, the advantage furthermore results that an oil pocket provided to reduce the bearing force can be structured to be longer over the circumference of the pivot motor housing. Likewise, a sealing segment that is also longer can be formed between the oil pocket and the chambers of the pivot motor. Furthermore, the vane can also be structured to be higher, thereby resulting in a low required pressure at the same required adjustment moment and the same length of the chambers of the pivot motor in the axial direction. Accordingly, the force component resulting from the oil pressure in the chambers of the pivot motor, which increases the bearing load, is reduced.

A vibration exciter for construction machines, particularly vibration pile drivers, having at least one axis having at least two imbalance masses, in which a pivot motor of the aforementioned type is provided to adjust the rotational position of at least one imbalance mass, is furthermore an object of the invention. Because at least one imbalance mass is formed by the housing of the pivot motor, the pivot motor shaft of which motor is disposed so to rotate relative to the mass, a significant reduction in the required construction space is achieved; in particular, a separate shaft for a phase shifter is not required.

In a further development of the invention, three imbalance masses are disposed on at least one axis. The center imbalance mass of these masses is formed by the pivot motor housing of the pivot motor, configured in the shape of a circle segment, the hollow shaft of which motor is an integral part of the axis. In this way, an imbalance shaft having an adjustable resulting imbalance is achieved.

### BRIEF DESCRIPTION OF THE DRAWINGS

Other further developments and embodiments of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a schematic representation of a vibrator transmission with three imbalance shafts;

FIG. 2 is a representation of the vibrator transmission from FIG. 1 in a front view;

FIG. 3 is a representation of the vibrator transmission from FIG. 1 in a side view;

FIG. 4 is a representation of an upper imbalance shaft of the vibrator transmission from FIG. 1;

FIG. 5 is a representation of the imbalance shaft from FIG. 4 with a cross-section that runs through the pivot motor;

FIG. 6 is a schematic representation of the imbalance shaft from FIG. 5

a) at the maximal static moment;

b) at a reduced static moment;

FIG. 7 is a schematic representation of the imbalance shaft from FIG. 4 in longitudinal section, with an introduced fixed lance for supplying oil;

FIG. 8 is a representation of the arrangement from FIG. 7 with the flange part removed;

FIG. 9 is a schematic representation of the lance of the arrangement from FIG. 7, with the flange part in place;

FIG. 10 is a schematic representation of the pivot motor of the imbalance shaft from FIG. 7 in cross-section, and

FIG. 11 is a schematic representation of a pivot motor configured in accordance with the arrangement according to FIG. 10, in an embodiment with an oil pocket.

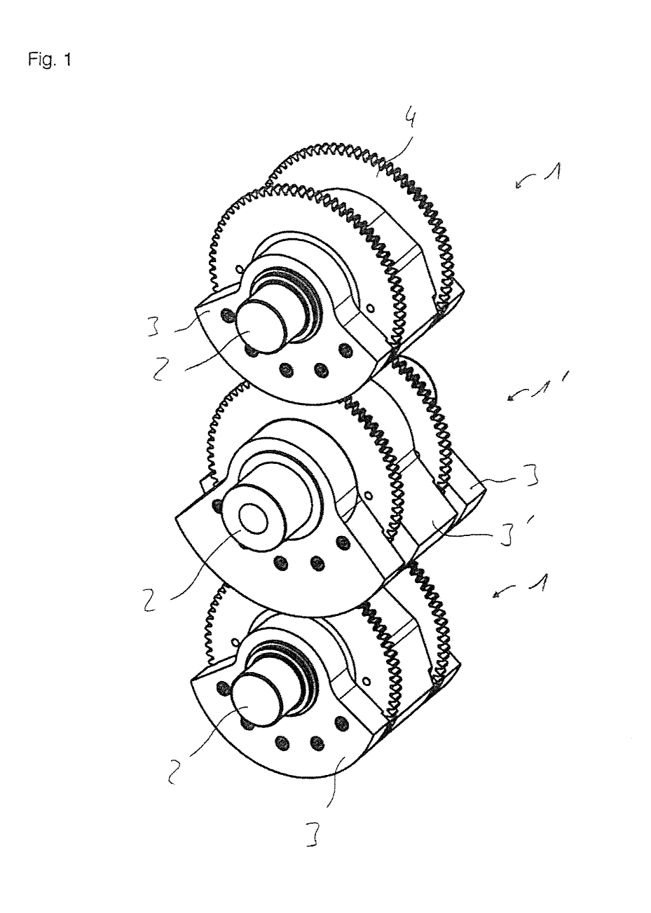

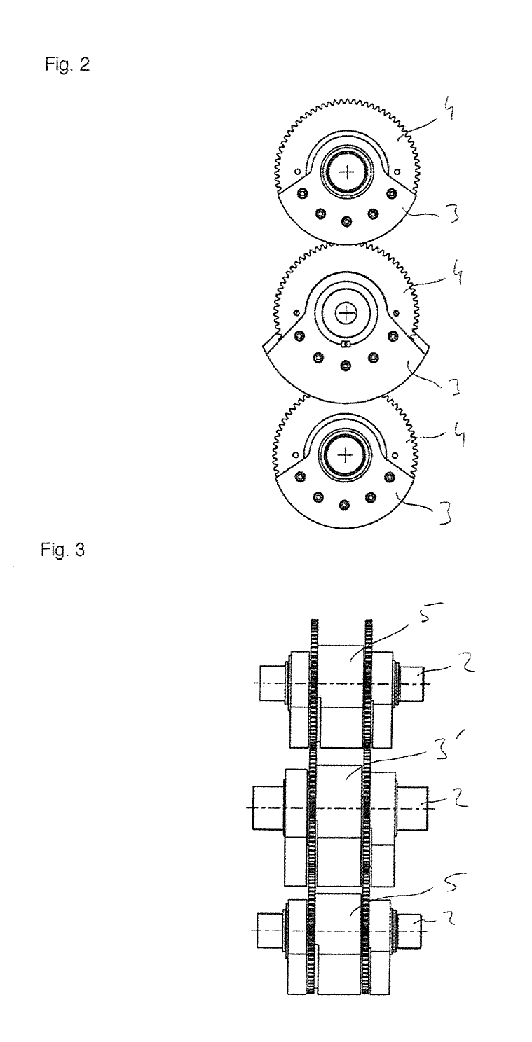

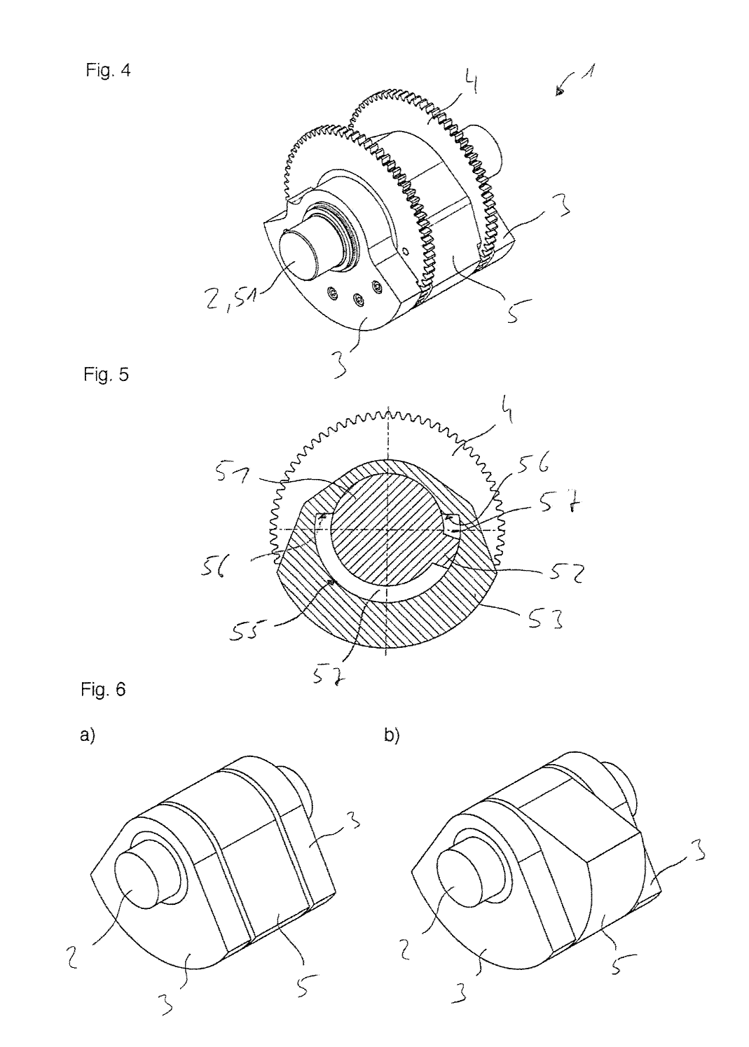

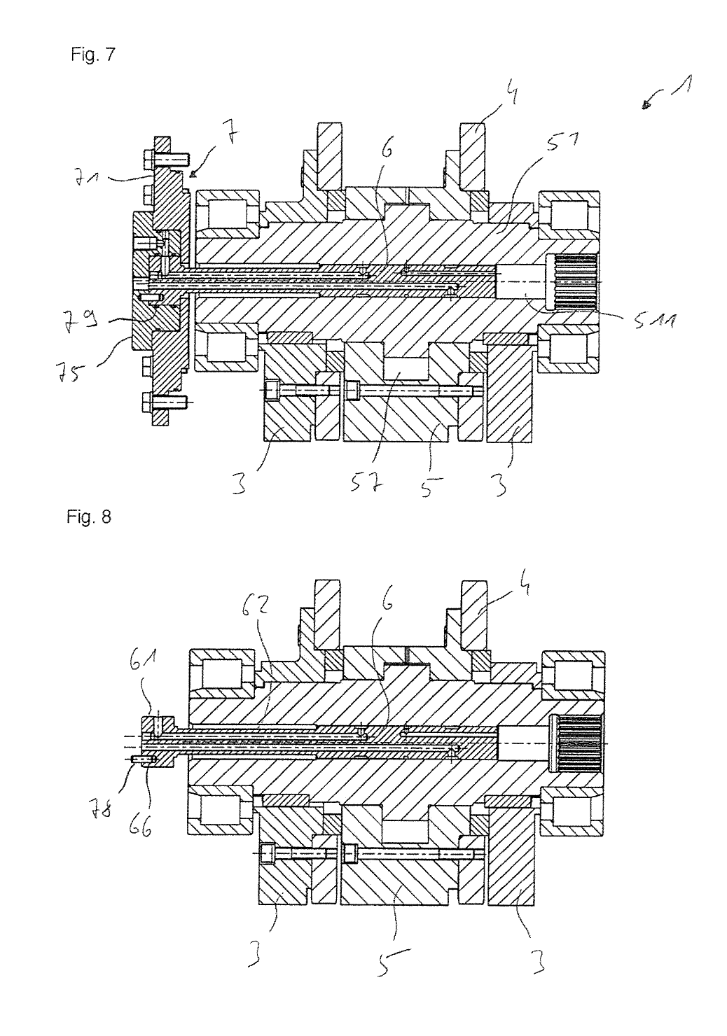

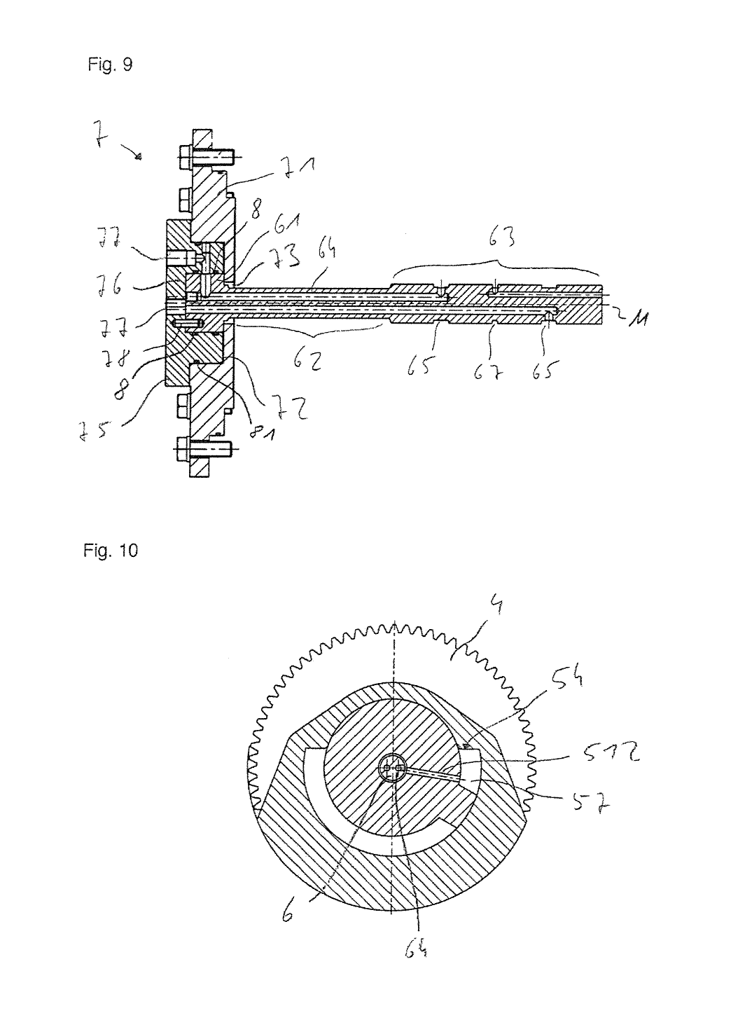

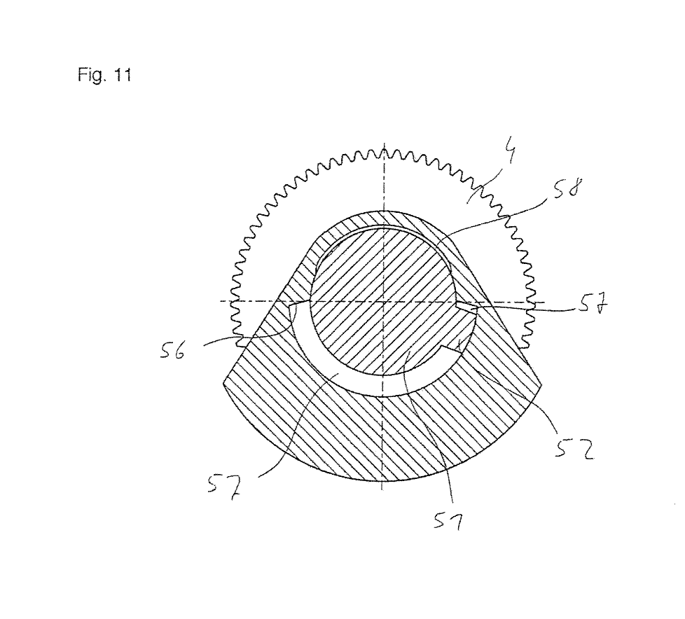

### DETAILED DESCRIPTION OF PREFERRED EMBODIMENTS

The vibration exciter selected as an exemplary embodiment is structured as a three-shaft vibrator transmission. Three imbalance shafts 1, 1′, 1 are provided, comprising an axis 2, on which two outer imbalance masses 3 are attached at a distance from one another. A gear wheel 4 is disposed on the axis 2 on the inner side disposed on the opposite outer imbalance mass 3, in each instance, adjacent to the outer imbalance masses 3, in each instance. At the outer imbalance shafts 1, a pivot motor 5 configured as a rotary piston pivot motor is disposed between the gear wheels 4, the pivot motor shaft 51 of which motor is an integral part of the axis 2. The center imbalance shaft 1′ has an inner imbalance mass 3′ on its axis 2, between the gear wheels 4. In this connection, the imbalance mass 3′ is dimensioned to be twice as wide as the outer imbalance masses 3.

The imbalance masses 3, 3′, 3 are configured to have the shape of a circle sector. In this connection, the radius of the outer imbalances 3 of the outer imbalance shafts 1 essentially corresponds to the radius of the gear wheels 4. The radius of the outer imbalance masses 3 and of the inner imbalance mass 3′ of the center imbalance shaft 1′ is clearly greater than the radius of the gear wheels 4 of the center imbalance shaft 1′, which are dimensioned to be larger than the gear wheels 4 of the outer imbalance shaft 1, between which a rotary piston pivot motor 5 is disposed.

The rotary piston pivot motor 5 is formed by a pivot motor shaft 51, which is an integral part of the axis 2, as well as by a pivot motor housing 53 disposed on the pivot motor shaft 51. In the exemplary embodiment, the pivot motor shaft is provided with an axial bore 511 from which two radial bores 512 are passed to the outside, at a distance from one another. On the outside, a rotary vane 52 is formed onto the pivot motor shaft 51, which vane is disposed within the pivot space 55 formed by the inner contour 54 of the pivot motor housing 53.

The pivot motor housing 53 is configured as an imbalance in the shape of a circle sector, corresponding to the imbalance masses 3, 3′. The pivot space 55 formed between the inner contour 54 of the pivot motor housing 53 and the pivot motor shaft 51 is limited by two stop surfaces 56, which allow a maximal angle of rotation of 150 degrees. Two chambers 57 for operation of the rotary piston pivot motor 5 are configured between the stop surfaces 56 of the pivot motor housing 53 and the rotary vane 52 of the pivot motor shaft 51.

A lance 6 for supplying the chambers 57 of the rotary piston pivot motor 5 with hydraulic oil is introduced into the axial bore 511 of the pivot motor shaft 51. The lance 6 is configured essentially cylindrically. At the end side, the lance 6 has a head piece 61, followed by a shaft 62, which makes a transition into a slide bearing section 63 that is enlarged in diameter. Two channels 64 for supplying the chambers 57 of the rotary piston pivot motor 5 are introduced into the lance 6, coaxial to its center axis 11. The channels 64 open into a ring groove 65 disposed within the slide bearing section 63, in each instance, which is disposed in such a manner that one of the radial bores 512 of the pivot motor 51 is disposed orthogonal to this groove, which axial bore 511 represents the connection with the chamber 57, in each instance, of the rotary piston motor 5. Sealing of the ring grooves 65 relative to the pivot motor shaft 51 takes place by way of a very narrow gap between the slide bearing section 63 and the inner wall of the axial bore 511 of the pivot motor shaft 51, whereby the slide bearing section is provided with a slide bearing coating made of plastic, in the exemplary embodiment.

The lance 6 is mounted, with its head piece 61, on a flange part 7 that is attached to the housing—not shown—of the vibrator transmission. The flange part 7 essentially consists of a base plate 71 that is connected centrally with a recess 72, configured in pot shape, which recess lies flush with a bore 73 passed through the base plate 71. The pot-shaped recess 72 accommodates the lid part 75, which is provided with a centrally disposed cylindrically configured recess 76, the outside diameter of which is slightly greater than the outside diameter of the head piece 61 of the lance 6. The lid part 75 is provided with supply connectors 77 for supplying the channels 64 of the lance 6 accommodated by the lid part 75. Furthermore, an alignment pin 78 for engagement in an alignment bore 66 disposed eccentrically in the head piece of the lance 6 is disposed in the recess 76 of the lid part 75. Two ring grooves 79 for accommodating an O-ring 8, in each instance, are introduced circumferentially around the recess 76 of the lid part 75, parallel to one another. The O-ring 8 bridges the gap between the head piece 61 of the lance 6 and the recess 76 of the lid part 75, thereby causing the head piece 61 to be mounted in the lid part 75 so as to pivot slightly. The lid part 75 is attached in the recess 72 of the base plate 71, and accommodates the head piece 61 of the lance 6, the shaft 62 of which projects through the bore 73 of the base plate, into the axial bore 511 of the pivot motor shaft 51 of the rotary piston pivot motor 5. In this connection, the lid part 75 is sealed relative to the pot-shaped recess 72, by means of an O-ring 81.

In the exemplary embodiment, the vibrator transmission is driven by means of two drives—not shown—that drive the uppermost and lowermost imbalance shaft 1, which is identical with the pivot motor shafts 51 of the rotary piston pivot motor 5 here.

The entire static moment of the upper and the lower imbalance shaft 1 corresponds to the static moment of the center imbalance shaft 1′; in the case of this three-shaft vibrator. For this reason, the imbalances 3 on the upper and lower imbalance shaft 1 do not take up the available construction space. A rotary piston pivot motor 5 is integrated into the upper and into the lower imbalance shaft 1, in each instance. This motor is situated in the center imbalance, in each instance. The pivot motor housing 53 of the rotary piston pivot motor 5 is configured as an imbalance mass in the shape of a circle segment, and is mounted on the imbalance shaft 1, in each instance, so as to rotate. The angle of rotation is limited to maximally 150 degrees by means of the rotary vane 52 formed onto the pivot motor shaft 51, in interaction with the stop surfaces 56 of the pivot space 55. The rotary vane 52 simultaneously serves as a seal between the two chambers 57 that are delimited between the rotary vane 52 and the pivot motor housing 53, as well as the pivot motor shaft 51. The two chambers 57 are supplied with hydraulic oil, which is fed in by way of the radial bores 512 of the pivot motor shaft 51. In order to feed the hydraulic oil to the rotating pivot motor shaft 51, the fixed lance 6 is mounted in the central, axially running bore 511. The sealing effect is achieved by means of tight gaps. In order to avoid excessive leakage, the hydraulic transmission is equipped with two pivot drives, thereby guaranteeing operation at low pressure, while simultaneously guaranteeing the required maximal torque of the pivot motors.

The hydraulic oil is fed to the channels 64 of the lance 6 by means of the supply connectors 77. From these channels 64, the oil gets into the ring grooves 65 on the outside of the lance. The chambers 57 of the rotary piston pivot motor 5 are closed off by means of radial bores 512, which connect the ring groove space, in each instance, with the corresponding chamber 57. Sealing of the ring grooves 65 relative to one another takes place by way of a narrow gap. In the exemplary embodiment, a leakage ring groove 67, which serves to conduct away any leakage oil that occurs, is disposed between the two ring grooves 65. The fit between the lance 6 and the axial bore 511 of the pivot motor shaft 51 is structured as a tight slide bearing in the region of the ring grooves 65, 67. In this region, the lance is provided with a slide bearing coating made of plastic, preferably polytetrafluoroethylene (commercially available under the trade name Teflon). A certain leakage exits through the slide bearing formed between the axial bore 511 of the pivot motor shaft 51 and the slide bearing section 63 of the lance 6, but this leakage simultaneously lubricates the bearing, separates the surfaces, and thereby counteracts friction wear.

Because the pivot motor housing 53 of the rotary vane pivot motor 5 is configured as an imbalance, in each instance, the bearings with which the pivot motor housing 53 is mounted on the pivot motor shaft 51 are increasingly stressed with centrifugal force at an increasing speed of rotation. In addition, a bearing force results from the oil pressure in the chambers 57. This bearing load, which results from centrifugal force and oil pressure in the chambers 57, leads to an increased adjustment moment. In order to at least partly compensate the resulting force that acts on the bearings, an oil pocket 58 can be additionally introduced into the pivot motor housing 53, to which pocket oil pressure can be applied (see FIG. 11). This oil pressure can be branched off, for example, when controlling the chambers 57. In this case, two kick-back valves or a shuttle valve are required to exclude a hydraulic short-circuit between the two chambers 57. Valves are sensitive, however, to dynamic stresses, which are unavoidable in a vibrator transmission. In order to avoid valves on the pivot motor and in order to be able to select the oil pressure in the oil pocket 58 independent of the adjustment pressure of the rotary vane pivot motor 5, it is possible to implement the oil supply in the oil pocket 58 by way of a separate connector. For example, the center connector formed by the leakage ring groove 67 can be used for this purpose.

Although only a few embodiments of the present invention have been shown and described, it is to be understood that many changes and modifications may be made thereunto without departing from the spirit and scope of the invention.

What is claimed is:

1. A pivot motor comprising:
(a) pivot motor shaft comprising an axial bore;
(b) a pivot motor housing mounted to rotate on the pivot motor shaft;
(c) a lance disposed in torque-proof manner projecting into the axial bore, said lance comprising at least first and second channels for supplying hydraulic oil to the pivot motor, said first and second channels ending in first and second ring grooves on an outside portion of the lance, at least in certain regions, at a distance from one another; and
(d) at least first and second pressure chambers for receiving the hydraulic oil for driving the pivot motor;
wherein the pivot motor shaft comprises radial bores for connecting the first and second ring grooves with the first and second pressure chambers; and
wherein a fit between the lance and the axial bore of the pivot motor shaft is structured as a tight slide bearing near the first and second ring grooves.

2. The pivot motor according to claim 1, wherein the lance is provided with a plastic coating near the ring grooves.

3. The pivot motor according to claim 2, wherein the plastic coating comprises polytetrafluoroethylene.

4. The pivot motor according to claim 1, wherein the lance has a reduced diameter near the shaft to increase elasticity.

5. The pivot motor according to claim 1, wherein the lance has an end side mounted with play in a flange part.

6. The pivot motor according to claim 5, wherein the lance on the end side has a head piece having an increased diameter for mounting the lance in the flange part.

7. The pivot motor according to claim 5, wherein the play forms a gap between the lance and the flange part and the gap is bridged by at least one O-ring.

8. The pivot motor according to claim 7, further comprising at least one alignment pin that projects eccentrically and axially into the lance to prevent rotation.

9. The pivot motor according to claim 1, wherein no seals are provided for sealing the pivot motor housing relative to the pivot motor shaft, and wherein a sealing effect is brought about exclusively by way of a gap dimension.

10. The pivot motor according to claim 2, wherein no slipping seals are present over a length of the fit between the lance and the axial bore of the pivot motor shaft near the ring grooves of the lance.

11. The pivot motor according to claim 10, wherein the pivot motor is a single-vane rotary piston pivot motor or a two-vane rotary piston pivot motor.

12. The pivot motor according to claim 1, wherein the pivot motor housing is configured as an imbalance in a shape of a circle segment, wherein the pivot motor is configured to have one vane.

13. The pivot motor according to claim 12, wherein the pivot motor comprises a rotary vane having an angle of rotation limited by first and second stop surfaces disposed on the pivot motor housing, wherein at least one oil pocket for receiving oil is formed between the first and second stop surfaces, opposite a pivot space of the rotary vane defined by the angle of rotation, wherein in order to supply oil to the at least one oil pocket, at least one separate channel is provided, in addition to the first and second channels supplying the hydraulic oil to the first and second pressure chambers disposed on first and second sides of the rotary vane, wherein said at least one channel is connected with a supply bore of a hollow shaft, opening into the at least one oil pocket, by way of a leakage ring groove disposed on the outside portion of the lance.

14. A vibration exciter for a construction machine comprising:
(a) at least one axis having at least first and second imbalance masses; and
(b) a pivot motor for adjustment of a rotational position of at least one of the first and second imbalance masses;
wherein the pivot motor comprises a pivot motor shaft comprising an axial bore, a pivot motor housing mounted to rotate on the pivot motor shaft, a lance disposed in torque-proof manner projecting into the axial bore, said lance comprising at least first and second channels for supplying hydraulic oil to the pivot motor, said first and second channels ending in first and second ring grooves on an outside portion of the lance, at least in certain regions, at a distance from one another, and at least first and second pressure chambers for receiving the hydraulic oil for driving the pivot motor;
wherein the pivot motor shaft comprises radial bores for connecting the first and second ring grooves with the first and second pressure chambers; and
wherein a fit between the lance and the axial bore of the pivot motor shaft is structured as a tight slide bearing near the first and second ring grooves.

15. The vibration exciter according to claim 14, further comprising a center imbalance mass disposed on the at least one axis between the first and second imbalance masses, wherein the center imbalance mass is formed by the pivot motor housing of the pivot motor, wherein the pivot motor shaft of the pivot motor is an integral part of the at least one axis, wherein the pivot motor housing is configured as an imbalance in a shape of a circle segment, and wherein the pivot motor is configured to have one vane.
